(19) United States
(12) Patent Application Publication
(10) Pub. No.: US 2018/0161991 A1
(43) Pub. Date: Jun. 14, 2018

(54) ROBOT, ROBOT CONTROL DEVICE, AND ROBOT SYSTEM

(71) Applicant: Seiko Epson Corporation, Tokyo (JP)

(72) Inventors: Shingo Hoshino, Hokuto (JP); Christoph Meyerhoff, Krefeld (DE); Tetsuya Kawase, Azumino (JP); Yuta Sato, Karuizawa (JP)

(21) Appl. No.: 15/831,962

(22) Filed: Dec. 5, 2017

(30) Foreign Application Priority Data
Dec. 12, 2016 (JP) 2016-240275

(51) Int. Cl. B25J 18/04; B25J 9/00; B25J 17/02; B25J 13/06

(52) U.S. Cl. CPC B25J 18/04; B25J 13/06; B25J 17/02; B25J 9/0009

(57) ABSTRACT

A robot includes two members that relatively rotate around a rotary shaft. The position of the rotary shaft for at least one of the two members is changed.

### BACKGROUND

### 1. Technical Field

The present invention relates to a robot, a robot control device, and a robot system.

### 2. Related Art

Research and development of a technology of broadening a movable range of a robot has been performed.

In this respect, there has been known a horizontal articulated robot including a first arm that is provided on a base and is rotatable around a first rotational axis, a second arm that is provided on the first arm to be rotatable around a second rotational axis that is parallel to the first rotational axis, and a main axis that is provided on the second arm and extends in a direction parallel to the second rotational axis, in which the second arm is configured to have an arm length as a distance between the second rotational axis and the main axis, which is shorter than an arm length of the first arm as a length of a centerline that straightly connects the first rotational axis and the second rotational axis, the first arm is eccentrical toward one of the rotating directions with respect to the centerline in vicinity of a position at which the centerline intersects with a revolving orbit that is formed around the second rotational axis and has a pivotal radius which is the arm length of the second arm (see JP-A-2013-233653).

In such a horizontal articulated robot, a first arm having a certain length may be possible to be changed to a first arm having a length different from the length of the first arm. In this case, the horizontal articulated robot is capable of performing predetermined work within a movable range corresponding to the length of the first arm. However, since the movable range of the horizontal articulated robot is determined to correspond to a ratio between the length of the first arm and the length of the second arm, it may not be possible for a user to change a movable range of a robot into a desired range corresponding to the length of the first arm.

### SUMMARY

An aspect of the invention is directed to a robot including: two members that relatively rotate around a rotary shaft, in which the position of the rotary shaft for at least one of the two members is changed.

According to this configuration of the robot, it is possible to change the position of the rotary shaft for at least one of the two members that are included in the robot and relatively rotate around a rotary shaft in the robot. In this manner, in the robot, it is possible to change a movable range into a range desired by a user.

In another aspect of the invention, the robot may be configured such that the two members are an assembly of an arm and a base or an assembly of an arm and an arm.

According to this configuration, the robot includes the two members, and the two members that relatively rotate around a rotary shaft are the assembly of an arm and a base or the assembly of an arm and an arm in the robot. In this manner, in the robot, the position of the rotary shaft with respect to at least one member in the assembly of the arm and the base or at least one member in the assembly of the arm and arm is changed, and thereby it is possible to change the movable range into a range desired by a user.

In another aspect of the invention, the robot may configured such that each of the two members is an arm, and a predetermined position of one of the two members passes above or below the other member such that the two members rotate with respect to each other when viewed in an axial direction of the rotary shaft direction.

According to this configuration, the predetermined position of the one of the two arms passes above or below the other member such that the two members rotate with respect to each other when viewed in the axial direction of the rotary shaft direction. In this manner, in the robot, it is possible to perform work depending on actuation desired by a user.

In another aspect of the invention, the robot may be configured such that the robot further includes a connecting portion that connects the two members to each other and a connecting position between at least one of the two members and the connecting portion is changed.

According to this configuration, the robot includes the two members and the connecting portion that connects the two members which relatively rotate around the rotary shaft and, in the robot, the connecting position between at least one of the two members and the connecting portion can be changed. In this manner, the robot includes the two members, in the robot, the connecting position between the connecting portion and at least one of the two members that relatively rotate around the rotary shaft is changed, and thereby it is possible to change the movable range into a range desired by a user.

In another aspect of the invention, the robot may be configured such that the robot further includes a base and may employ a configuration in which the two members are a first arm that is provided on the base and a second arm that is provided on the first arm, and the second arm is provided on the base on a side of an installation surface with respect to the first arm in the axial direction of the rotary shaft.

According to this configuration of the robot, the second arm is provided on the base on a side of an installation surface with respect to the first arm in the axial direction of the rotary shaft. In this manner, in the robot, it is possible to reduce the size of the robot.

In another aspect of the invention, the robot may be configured to further include a robot control device that is provided in the base and controls the robot.

According to this configuration, the robot control device is provided in the base and controls the robot. In this manner, in the robot, it is possible to reduce an occupation area of a range in which the robot is installed, compared to a case where a robot control device is provided outside the base.

In another aspect of the invention, the robot may be configured such that the second arm is provided with a plurality of through-holes that penetrate through the second arm in the axial direction of the rotary shaft, and an actuation shaft that penetrates through the first through-hole as one of the through-holes and a drive unit that drives the actuation shaft, and layout of wiring that is connected to the drive unit is performed through at least a portion of second through-holes which are one or more through-holes different from the first through-hole of the through-holes.

According to this configuration, the layout of the wiring that is connected to the drive unit is performed through at least a portion of second through-holes which are one or more through-holes different from the first through-hole of the through-holes among the plurality of through-holes that penetrate through the second arm. In this manner, in the robot, it is possible to reduce an occurrence of disconnection of the wiring, compared to a case where wiring is connected to a drive unit through a portion of a joint between the first arm and the second arm.

In another aspect of the invention, the robot may be configured such that a portion or all of the one or more second through-holes are provided with a third through-hole that is connected to the second through-hole in a direction intersecting with an axial direction of the actuation shaft in the second arm.

According to this configuration, a portion or all of the one or more second through-holes are provided with the third through-hole that is connected to the second through-hole in a direction intersecting with an axial direction of the actuation shaft in the second arm. In this manner, in the robot, it is possible to connect the wiring to a device that is desired by a user through the third through-hole.

In another aspect of the invention, the robot may be configured such that the wiring that is connected to an end effector provided on the actuation shaft passes through the third through-hole.

According to this configuration, the wiring that is connected to the end effector provided on the actuation shaft passes through the third through-hole. In this manner, in the robot, it is possible to reduce the portion of the layout of wiring to an outer circumferential portion of the robot of the wiring connected to the end effector. As a result, in the robot, it is possible to reduce the occurrence of disconnection of the wiring that is connected to the end effector.

In another aspect of the invention, the robot may be configured to further include an attachment portion that enables an object to be attached to two or more sites different from each other of sites of the base.

According to this configuration, the attachment portion enables the object to be attached to two or more sites different from each other of sites of the base. In this manner, in the robot, it is possible to attach the object, which is desired by a user, to the site, which is desired by a user.

In another aspect of the invention, the robot may be configured such that at least one of a movable portion and a port to which wiring is connected is provided as the object on the attachment portion.

According to this configuration, at least one of the movable portion and the port to which the wiring is connected is provided as the object on the attachment portion. In this manner, in the robot, it is possible to attach at least one of the movable portion and the port, to which the wiring is connected, to a position that is desired by a user.

In another aspect of the invention, the robot may be configured such that a site to which the attachment portion can be attached includes a first site provided with a first opening and a second site provided with a second opening, and the first opening and the second opening are connected to each other.

According to this configuration, the site to which the attachment portion can be attached includes the first site provided with a first opening and a second site provided with a second opening, and the first opening and the second opening are connected to each other. In this manner, in the robot, it is possible to easily change the site to which the attachment portion is attached, by a user.

Another aspect of the invention is directed to a robot control device that controls the robot described above.

According to this configuration, the robot control device can control the robot of which a movable range can be changed into a range desired by a user. In this manner, the robot control device can cause the robot to perform work within a range desired by a user.

Another aspect of the invention is directed to a robot system including the robot described above; and the robot control device that controls the robot.

According to this configuration, it is possible to change the position of the rotary shaft for at least one of the two members that are included in the robot and relatively rotate around a rotary shaft in the robot. In this manner, in the robot system, it is possible to change the movable range into a range that is desired by a user.

As described above, in the robot and the robot system, it is possible to change the position of the rotary shaft for at least one of the two members that are included in the robot and relatively rotate around a rotary shaft in the robot. In this manner, in the robot and the robot system, it is possible to change the movable range into a range that is desired by a user.

In addition, in the robot control device, it is possible to control a robot of which the movable range can be changed into a range that is desired by a user. In this manner, the robot control device can cause the robot to perform work within a range desired by a user.

### BRIEF DESCRIPTION OF THE DRAWINGS

The invention will be described with reference to the accompanying drawings, wherein like numbers reference like elements.

FIG. 1 is a diagram illustrating an example of a configuration of a robot according to an embodiment.

FIG. 2 is a view illustrating an example of the robot after an arm member included in a first arm illustrated in FIG. 1 is replaced with another arm member.

FIG. 3 is a view illustrating an example of the robot after the robot illustrated in FIG. 2 causes a second arm to rotate around a second axis by 180°.

FIG. 4 is a view illustrating an example of a movable range of the robot in a case where the robot illustrated in FIG. 2 is viewed from a first viewpoint.

FIG. 5 is a view illustrating an example of the robot after the second arm is caused to slide in a second frontward direction with respect to a pinching portion in the robot illustrated in FIG. 2.

FIG. 6 is a view illustrating an example of the robot after the robot illustrated in FIG. 5 causes the second arm to rotate around the second axis by 180°.

FIG. 7 is a view illustrating an example of a movable range of the robot in a case where the robot illustrated in FIG. 5 is viewed from the first viewpoint.

FIG. 8 is a view illustrating an example of the robot after a support is caused to slide in a first frontward direction or a first rearward direction with respect to the first arm in the robot illustrated in FIG. 2.

FIG. 9 is a view illustrating an example of the robot after the first arm is caused to slide in a first rearward direction with respect to a first axis in the robot illustrated in FIG. 2.

FIG. 10 is a view illustrating an example of the first arm including the arm member on which a rail is formed.

FIG. 11 is a view illustrating an example of an arm member that is included in the first arm and can be disassembled into a plurality of members in a longitudinal direction.

FIG. 12 is a view illustrating an example of the robot after the second arm is caused to slide downward along the second axis in the robot illustrated in FIG. 1.

FIG. 13 is a view illustrating an example of the robot after the second arm is caused to rotate around the second axis in the robot illustrated in FIG. 1.

FIG. 14 is a view illustrating an example of another robot including only one arm.

FIG. 15 is a view illustrating an example of a configuration of still another robot.

FIG. 16 is a perspective view illustrating an example of an internal structure of a cylindrical portion.

FIG. 17 is a view illustrating an example of a second arm in which horizontal through-holes are formed.

FIG. 18 is a view illustrating an example of a configuration of a base.

FIG. 19 is a view illustrating an example of a state in which one member is attached on the underside of a housing and another member is attached on a back surface of the housing.

FIG. 20 is a view illustrating an example of the housing from which the one member and the other member are detached.

FIG. 21 is a view illustrating an example of the housing in which a partition illustrated in FIG. 20 is omitted.

FIG. 22 is a view illustrating an example of the housing to which an L-shaped member is attached such that the one member blocks one opening.

FIG. 23 is a view illustrating an example of the housing to which an L-shaped member is attached such that the one member blocks the other opening.

FIG. 24 is a view illustrating an example of the base in a case where an attachment portion is a box-shaped member.

FIG. 25 is a view illustrating an example of the base in a case where the box-shaped member illustrated in FIG. 24 is caused to rotate counterclockwise by 90° with respect to a flat plate in a case where the base is viewed from a viewpoint opposite to a first viewpoint.

FIG. 26 is a view illustrating an example of the base in a case where the box-shaped member illustrated in FIG. 24 is caused to rotate counterclockwise by 180° with respect to a flat plate in a case where the base is viewed from a viewpoint opposite to a first viewpoint.

FIG. 27 is a view illustrating an example of the base in a case where the box-shaped member illustrated in FIG. 24 is caused to rotate counterclockwise by 270° with respect to the flat plate in a case where the base is viewed in a direction from the underside to the top surface of the box-shaped member.

FIG. 28 is a view illustrating an example of a case of the base in which a port is attached to the underside of the base illustrated in FIG. 24.

### DESCRIPTION OF EXEMPLARY EMBODIMENTS

Hereinafter, an embodiment of the invention will be described with reference to the figures.

### Configuration of Robot

First, a configuration of a robot 1 is described.

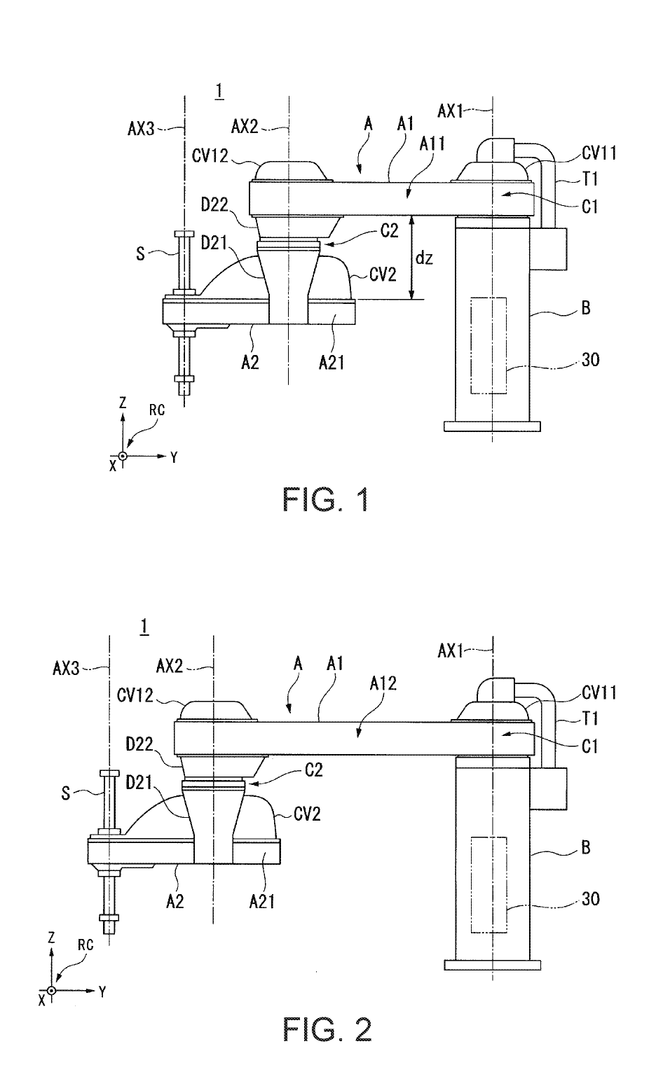

FIG. 1 is a diagram illustrating an example of the configuration of the robot 1 according to the embodiment. The robot 1 is a SCARA robot (horizontal articulated robot) including a base B and a movable unit A supported by the base B. The robot 1 may be another robot such as a vertical articulated robot or a cartesian coordinate robot, instead of the SCARA robot. The vertical articulated robot may be a single-arm robot including one arm, a dual-arm robot (multi-arm robot including two arms) including two arms, or a multi-arm robot including three or more arms. In addition, the cartesian coordinate robot is, for example, a gantry robot.

The base B is installed on an installation surface such as a floor or a wall surface. Hereinafter, for convenience of description, in a direction orthogonal to the installation surface, a direction from the robot 1 to the installation surface is referred to as a downward direction, and a direction opposite to the downward direction is referred to as an upward direction in the following description. Hereinafter, as an example, a case where the downward direction matches the negative direction of a Z axis in a robot coordinate system RC of the robot 1 will be described. In this configuration, the downward direction may not match the negative direction.

As illustrated in FIG. 1, for example, the base B has a substantially rectangular parallelepiped shape of which the longitudinal direction is a vertical direction. In addition, the base B is hollowed. A movable unit A is provided on the top surface of the base B. In other words, the base B supports the movable unit A. Instead of such a shape, the base B may have another shape such as a cubic shape, a cylindrical shape, or a polyhedral shape as long as the movable unit A can be supported with the shape.

The movable unit A includes a first arm A1 that is supported by the base B to be rotatable around the first axis AX1, a second arm A2 that is supported by the first arm A1 to be rotatable around the second axis AX2, and a shaft S that is supported by the second arm A2 to be rotatable around a third axis AX3 and translating in an axial direction of the third axis AX3. In this example, the first axis AX1 to the third axis AX3 are axes parallel to the Z axis in the robot coordinate system RC. Some or all of the first axis AX1 to the third axis AX3 may be axes which are nonparallel to the Z axis. Hereinafter, for convenience of description, in the robot coordinate system RC, a direction along an XY plane as the direction from the first axis AX1 to the second axis AX2, is referred to as a first frontward direction, and a direction along the XY plane as the direction from the second axis AX2 to the first axis AX1, is referred to as a first rearward direction. In addition, hereinafter, in the robot coordinate system RC, a direction along the XY plane as the direction from the second axis AX2 to the third axis AX3 is referred to as a second frontward direction, and a direction along the XY plane as the direction from the third axis AX3 to the second axis AX2 in the direction along the XY plane, is referred to as a second rearward direction.

The shaft S is a shaft body having a cylindrical shape. A circumferential surface of the shaft S is provided with both of a ball screw groove (not illustrated) and a spline groove (not illustrated). The circumferential surface of the shaft S may not be provided with the spline groove, but may be configured to be provided with the ball screw groove. The shaft S is provided to penetrate through an end portion of the second arm A2 on a side (that is, a side of the second frontward direction) opposite to the first arm A1 of the end portions thereof in a Z-axis direction in the robot coordinate system RC. In addition, an end effector is attachable to a lower end portion of the end portions of the shaft S. The end effector may be an end effector that is capable of holding an object, or another end effector that is capable of suctioning an object with air, magnetic force, or the like, or may be still another end effector. The shaft S is an example of an actuation shaft.

The first arm A1 includes an arm member having a length, which is desired by a user, of a plurality of types of arm members having different lengths from each other. The length is a length in the first front direction in a case where the robot 1 includes the arm member. In other words, the user can replace the arm member included in the first arm A1 with any of the plurality of types of arm members.

Hereinafter, as an example, a case where the plurality of types of arm members, which are replaceable in the first arm A1, have the same shape as each other except for the length will be described. For example, each of the plurality of types of arm members has a substantially rectangular parallelepiped shape. Instead, each of the plurality of types of arm members may have another shape such as a cubic shape, a cylindrical shape, or a polyhedral shape. In this configuration, some or all of the plurality of types of the arm members may be configured to have shapes different from each other.

In addition, in a case where the top surface and the underside of each of the plurality of types of arm members, which are replaceable in the first arm A1 are provided in the first arm A1, the top surface and the underside are parallel to the XY plane in the robot coordinate system RC. One or both of the top surface and the underside may be nonparallel to the XY plane. In the example illustrated in FIG. 1, the first arm A1 includes an arm member A11 as an arm member having a length, which is a reference, of a plurality of types of arm members.

The top surface (in the example illustrated in FIG. 1, the top surface of the arm member A11) of the arm member included in the first arm A1 is provided with one or more covers that covers at least a part of the top surface. In the example illustrated in FIG. 1, the top surface is provided with two covers of a cover CV11 and a cover CV12. The cover CV11 covers a surface having a portion, which intersects with the second axis AX1, of a part of a surface of the top surface. The cover CV12 covers a surface having a portion, which intersects with the second axis AX2, of a part of a surface of the top surface. A configuration, in which one or both of the cover CV11 and the cover CV12 is not provided on the top surface, may be employed.

In this example, since the first arm A1 rotates around the first axis AX1, the first arm moves in a horizontal direction. The horizontal direction is a direction orthogonal to the vertical direction in one example. In other words, in this example, the horizontal direction is a direction along the XY plane in the robot coordinate system RC. The first arm A1 is caused to rotate around the first axis AX1 by a motor 41 included in the base B. In other words, the first axis AX1 is an axis that matches a rotary shaft of the motor 41 and is an axis representing the rotational center of each of two members (in this example, the first arm A1 and the base B), which relatively rotate from each other in response to the rotation of the motor 41. In FIG. 1, the motor 41 is omitted due to the simplification of FIG. 1.

In addition, a connecting portion C1 that connects the base B and the first arm A1 is provided at an end portion of the first arm A1 on the side of the base B (that is, the side in the first rearward direction) of the end portions thereof. In FIG. 1, only the position of the connecting portion C1 is illustrated due to the simplification of FIG. 1. For example, the connecting portion C1 is a spacer and mechanically connects a rotary shaft of the motor 41 and the first arm A1 with a bolt. Instead, the connecting portion C1 may be configured to connect the rotary shaft and the first arm A1 by another method.

In addition, a connecting portion C2 that connects the first arm A1 and the second arm A2 is provided on the underside of an end portion of the first arm A1 on the side opposite to the base B (that is, the side in the first rearward direction) of the end portions thereof. The connecting portion C2 includes a pinching portion D21 that pinches (holds) the second arm A2 from above and a support D22 that supports the pinching portion D21. In addition, the support D22 includes a motor 42. Instead of a configuration of pinching the second arm A2 from above, the pinching portion D21 may be configured to hold the second arm A2 by another method. The pinching portion D21 is caused to rotate around the second axis AX2 by the motor 42 included in the support D22. In other words, the pinching portion D21 is rotatable along with the second arm A2 around the second axis AX2 with respect to the support D22. The support D22 is fixed to the first arm A1 not to relatively move with respect to the first arm A1. The support D22 may be relatively movable with respect to the first arm A1. In addition, the connecting portion C2 may be configured to be provided on the top surface of the end portion of the first arm A1 on the side opposite to the base B (that is, the side in the first frontward direction) of the end portions thereof. In this case, the second arm A2 is supported on the top surface of the first arm A1.

The second arm A2 includes an arm member A21. The arm member A21 is a member having a substantially rectangular parallelepiped shape. Instead, the shape may be another shape such as a cubic shape, a cylindrical shape, or a polyhedral shape. The top surface and the underside of the arm member A21 is parallel to the XY plane in the robot coordinate system RC. The top surface and the underside may be nonparallel to the XY plane.

The top surface of the arm member A21 is provided with one or more covers that covers at least a part of the top surface. In the example illustrated in FIG. 1, the top surface is provided with one cover of a cover CV2 that covers the entire top surface except for a through-hole through which the shaft S penetrates. Two motors of a motor 43 and a motor 44 described above are disposed inside the cover CV2 (that is, inside the second arm A2).

The second arm A2 is pinched by the pinching portion D21 described above from above. In addition, the second arm A2 is fixed to the pinching portion D21 with a screw, a bolt, or the like. In this case, a side surface of the arm member A21 included in the second arm A2 is provided with a plurality of screw holes (fastening holes). The second arm A2 may be configured to be fixed to the pinching portion D21 by another method.

In this example, since the second arm A2 rotates around the second axis AX2, the second arm moves in the horizontal direction. The second arm A2 is caused to rotate along with the pinching portion D21 around the second axis AX2 by the motor 42 included in the support D22 described above. In other words, the second axis AX2 is an axis that matches a rotary shaft of the motor 42 and is an axis representing the rotational center of each of two members (in an example thereof, the second arm A2 and the first arm A1), which relatively rotate from each other in response to the rotation of the motor 42. In FIG. 1, the motor 42 is omitted due to the simplification of FIG. 1.

In addition, the second arm A2 includes the motors 43 and 44 and supports the shaft S. A ball screw nut provided in an outer circumferential portion of a ball screw groove of the shaft S is caused to rotate by a timing belt or the like, and thereby the motor 43 causes the shaft S to move (be lifted and lowered) in the vertical direction. A ball spline nut provided in an outer circumferential portion of a spline groove of the shaft S is caused to rotate by a timing belt or the like, and thereby the motor 44 causes the shaft S to rotate around the third axis AX3. In FIG. 1, the motors 43 and 44 are omitted due to the simplification of FIG. 1.

Hereinafter, as an example, a case where all of the motors 41 to 44 have the same configuration will be described. Some or all of the plurality of the motors 41 to 44 may be the motors having different configurations from each other.

In addition, a distance dz from the top surface of the arm member A21 to the underside of the arm member (in the example illustrated in FIG. 1, the arm member A11) included in the first arm A1 is longer than the maximum shaft projecting length in an example thereof. The maximum shaft projecting length is a distance from the upper end portion of the shafts to the top surface of the arm member A21 in a case where the robot 1 causes the shaft S to move to a limit in the upward direction. Therefore, a position of the second arm A2, at which the shaft S is provided, passes below the first arm A1 such that the second arm rotates when the robot 1 is viewed from a first viewpoint. The first viewpoint is a viewpoint of looking the robot 1 downward from above (along the second axis AX2). In other words, the second arm A2 rotates around the second axis AX2, and thereby the second front direction can match the first rear direction. In other words, the second arm A2 rotates with respect to the first arm A1, and thereby the shaft S can pass below the first arm A1 in the horizontal direction in this case. In this manner, the robot 1 can perform various types of actuation compared to a robot (for example, a robot in the related art) different from the robot 1. As a result, the robot 1 can perform work depending on actuation desired by a user. The distance dz may be a distance equal to or longer than the maximum shaft projecting length. In this case, in order to overlap the first arm A1 and the second arm A2 in a case where the robot 1 is viewed from the first viewpoint, the robot 1 needs to cause the shaft S to move downward such that the upper end portion of the shaft S is lower than the underside of the first arm A1. The position of the second arm A2 at which the shaft S is provided is an example of a predetermined position of one of two members that relatively rotate around the rotary shaft.

In addition, since the second arm A2 is provided below the first arm A1 in the robot 1, a length of the base B in the vertical direction of the lengths of the base is longer, compared to a case where the second arm A2 is provided above the first arm A1. Therefore, in the robot 1, since a space inside the base B is broadened, compared to the case, a robot control device 30 may be easily installed in the internal space of the base B. Hereinafter, as an example, a case where the robot control device 30 is installed in the space in the robot 1 will be described. In this case, the robot 1 can occupy a small occupation area in a range in which the robot 1 is installed, compared to a case where the robot control device 30 is provided outside the base B. The robot 1 may be configured to have the robot control device 30 that is separately and externally installed from the robot 1, instead of the configuration of the internal robot control device 30.

Here, in this example, since the robot control device 30 is installed in the internal space of the base B, a tube T1 that connects the base B and the cover CV11 is provided to the base B and the cover C11. The tube T1 is a tube through which various types of wiring connected from the robot control device 30 to each of the motors 42 to 44 pass. Hereinafter, for convenience of description, a surface, on which the tube T1 is provided, of the surfaces of the base B is referred to as a back surface of the base B.

The robot 1 may be configured to include some or all of an imaging unit (camera), an end effector, and various types of sensors such as a gyroscope sensor or a force sensor.

The robot control device 30 is a controller that controls the robot 1. The robot control device 30 actuates the robot 1 based on an actuation program that has been stored by a user in advance. In this manner, the robot control device 30 can cause the robot 1 to perform predetermined work.

### Movable Range of Robot and Change Thereof

Hereinafter, a movable range of the robot 1 is described. In an example thereof, the movable range of the robot 1 is a range in a case where the robot 1 is viewed from the first viewpoint, as a range in which the lower end portion of the shaft S (or the third axis AX3) is movable. Instead, the movable range of the robot 1 may be a range in which an end effector is movable in the range obtained in this case. In this case, the end effector is attached to the lower end portion.

Here, the movable range of the robot 1 is determined depending on a ratio between the length of the first arm A1 and the length of the second arm A2. Therefore, in the robot 1, the arm member A1 of the first arm A1 is replaced with an arm member having a length different from the length of the arm member A11, and thereby it is possible to change the length of the first arm A1. In this manner, it is possible for a user to change the movable range of the robot 1.

FIG. 2 is a view illustrating an example of the robot 1 after the arm member A11 of the first arm A1 illustrated in FIG. 1 is replaced with the arm member A12. In the example illustrated in FIG. 2, the arm member A12 is an arm member having a length longer than the length of the arm member A11. Therefore, a thirteenth positive-direction distance in the robot 1 illustrated in FIG. 2 is longer than a thirteenth positive-distance in the robot 1 illustrated in FIG. 1. The thirteenth positive-direction distance is a distance between the third axis AX3 and the first axis AX1, as a distance along the XY plane in the robot coordinate system RC in a case where the robot 1 causes the first frontward direction and the second frontward direction to match each other (in a case where the third axis AX3 and the first axis AX1 are most separated from each other. In this configuration, the length of the arm member A12 may be shorter than the length of the arm member A11.

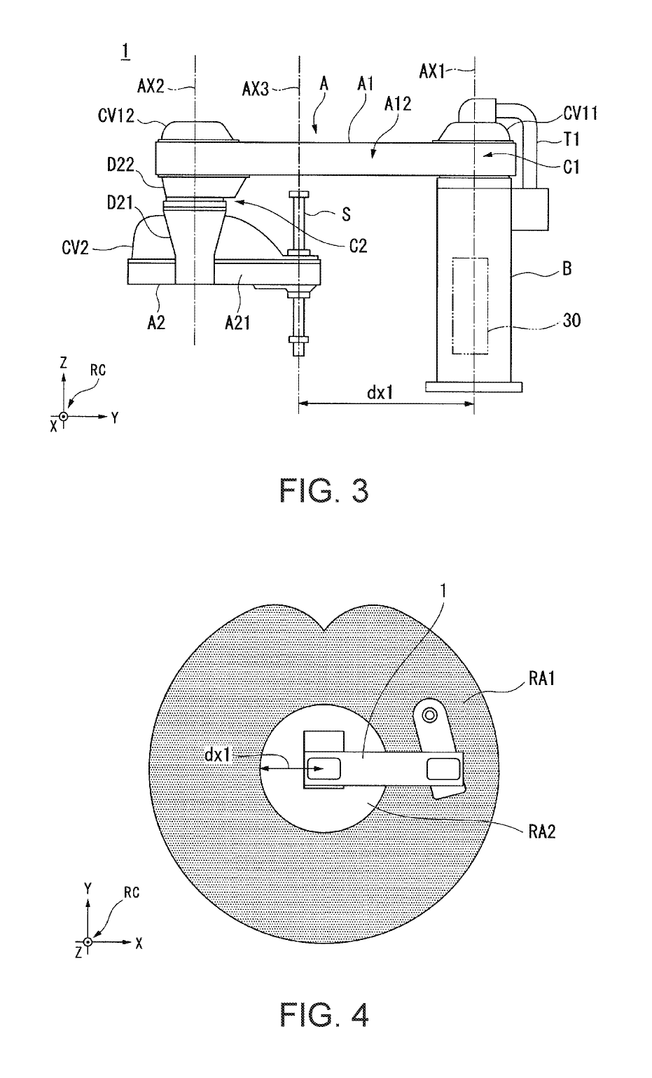

FIG. 3 is a view illustrating an example of the robot 1 after the robot illustrated in FIG. 2 causes the second arm A2 to rotate around the second axis AX2 by 180°. In addition, a distance dx1 as a thirteenth negative-direction distance in the robot 1 illustrated in FIG. 3 is longer than a thirteenth negative-distance in the robot 1 illustrated in FIG. 1. The thirteenth negative-direction distance is a distance between the third axis AX3 and the first axis AX1, as a distance along the XY plane in the robot coordinate system RC in a case where the robot 1 causes the first frontward direction and the second rearward direction to match each other (in a case where the third axis AX3 and the first axis AX1 are closest to each other.) In other words, the longer the distance of the first arm A1 in the longitudinal direction, the longer the distance dx1.

In a case where the arm member of the first arm A1 is replaced with the arm member A12 from the arm member A11, the movable range of the robot 1 is set to a range RA1 illustrated in FIG. 4. FIG. 4 is a view illustrating an example of a movable range of the robot 1 in a case where the robot 1 illustrated in FIG. 2 is viewed from the first viewpoint. The region RA1 represented by a hatched region in FIG. 4 represents the movable range of the robot 1 illustrated in FIG. 2. The range RA1 has a substantially circular shape in a case where the robot 1 is viewed from the first viewpoint. In addition, a region RA2 as a region surrounded by the region RA1 is a region in which it is not possible for the lower end portion of the shaft S of the robot 1 to move. Hereinafter, for convenience of description, the region is referred to as a non-movable range. The range RA2 has a circular shape in a case where the robot 1 is viewed from the first viewpoint. In addition, a radius of the range RA2 is a distance dx1 illustrated in FIG. 3. In other words, in the robot 1, the longer the length of the first arm A1, the larger the radius of the outer circumference representing the movable range; however, the longer the length of the first arm A1, the larger that radius of the circumference representing the non-movable range.

Here, in the robot 1 in an example thereof, it is possible to change the position of the second axis AX2 with respect to at least one member of an assembly of the first arm A1 and the second arm A2. Specifically, in the robot 1, a pinching position of the second arm A2 by the pinching portion D21 is changed, and thereby the second arm A2 can be caused to slide in the second frontward direction or the second rearward direction with respect to the pinching portion D21. In other words, in the robot 1, it is possible to change the position of the second axis AX2 with respect to the second arm A2. In this manner, in the robot 1, the radius of the outer circumference of the movable range is increased, and it is possible to reduce the radius of the circumference representing the non-movable range. In order to realize this, each of two surfaces of the arm member A21 which are orthogonal to a transverse direction of the surfaces of the arm member A21 is provided with a plurality of screw holes (fastening holes) corresponding to each of the pinching portions of the second arm A2 by the pinching portion D21. A user selects the pinching position that the user desires, and the second arm A2 is fixed to the pinching portion D21 by using the screw holes corresponding to the selected pinching portion. In this manner, it is possible for the user to change the position of the second axis AX2 with respect to the second arm A2 in the robot 1. Another configuration such as a configuration, in which a rail is provided on the two surfaces, instead of the plurality of screw holes, or a configuration in which the second arm A2 is caused to slide in the second frontward direction or the second rearward direction with respect to the pinching portion D21 may be employed. In addition, the robot 1 may have a configuration of including a mechanism unit that causes the second arm A2 to slide in the second frontward direction or the second rearward direction with respect to the pinching portion D21. In this case, the user manually drives or the robot control device 30 performs controlling to drive the mechanism unit, and the second arm A2 is caused to slide in the second frontward direction or the second rearward direction with respect to the pinching portion D21.

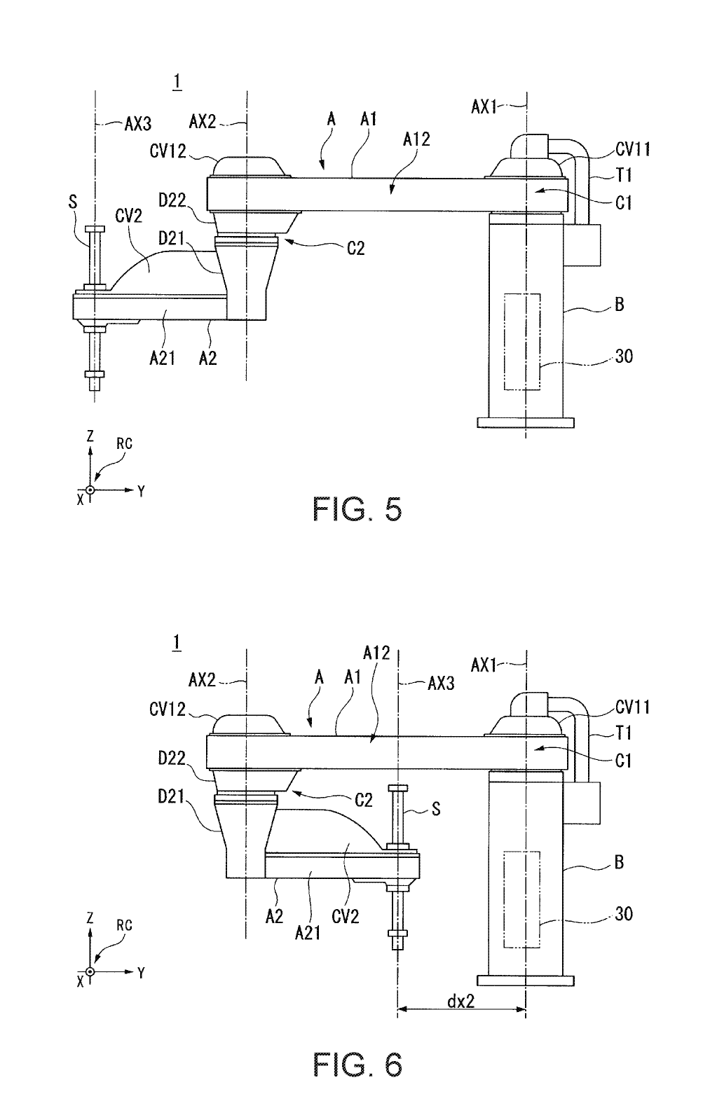

FIG. 5 is a view illustrating an example of the robot 1 after the second arm A2 is caused to slide in the second frontward direction with respect to the pinching portion D21 in the robot 1 illustrated in FIG. 2. A thirteenth positive-direction distance in the robot 1 illustrated in FIG. 5 is longer than the thirteenth positive-distance in the robot 1 illustrated in FIG. 2. In other words, in a case where the second arm A2 is caused to slide in the second frontward direction with respect to the pinching portion D21 in the robot 1 illustrated in FIG. 2, the radius of the outer circumference of the movable range of the robot 1 is increased.

In addition, FIG. 6 is a view illustrating an example of the robot 1 after the robot 1 illustrated in FIG. 5 causes the second arm A2 to rotate around the second axis AX2 by 180°. In addition, a distance dx2 as a thirteenth negative-direction distance in the robot 1 illustrated in FIG. 5 is shorter than the thirteenth negative-distance in the robot 1 illustrated in FIG. 3. In other words, as the second arm A2 is caused to slide in the second frontward direction with respect to the pinching portion D21 in the robot 1 illustrated in FIG. 2, the distance dx2 is decreased. In other words, in a case where the second arm A2 is caused to slide in the second frontward direction with respect to the pinching portion D21 in the robot 1 illustrated in FIG. 2, the radius of the circumference of the non-movable range of the robot 1 is decreased.

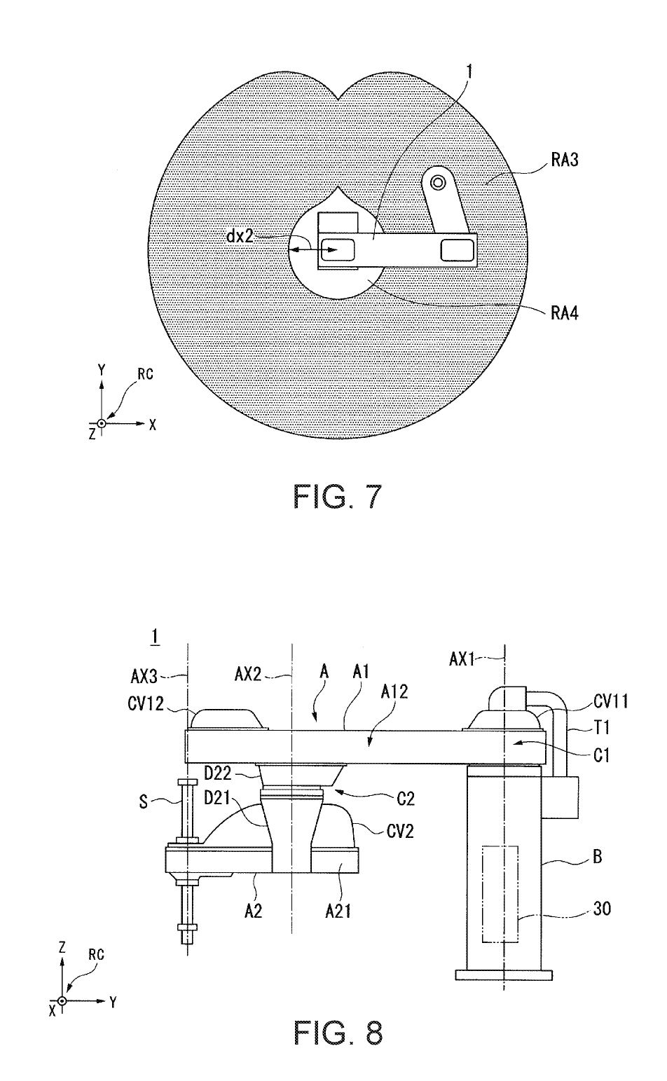

In a case where the second arm A2 is caused to slide in the second frontward direction with respect to the pinching portion D21 in the robot 1 illustrated in FIG. 2, the movable range of the robot 1 is set to a region RA3 illustrated in FIG. 7. FIG. 7 is a view illustrating an example of the movable range of the robot 1 in a case where the robot 1 illustrated in FIG. 5 is viewed from the first viewpoint. The region RA3 represented by a hatched region in FIG. 7 represents the movable range of the robot 1 illustrated in FIG. 5. In addition, a region RA4 as a region surrounded by the region RA3 is a non-movable region of the robot 1 illustrated in FIG. 5. In addition, a radius of the range RA4 is a distance dx2 illustrated in FIG. 6. In other words, it is possible to broaden or narrow the movable range by changing the position of the second axis AX2 with respect to the second arm A2 in the robot 1. As a result, in the robot 1, it is possible to change the movable range into a range desired by a user.

Instead of a configuration in which it is possible to change the movable range of the robot 1 by changing the position of the second axis AX2 with respect to the second arm A2, the robot 1 may have a configuration in which it is possible to change the movable range of the robot 1 by changing the position of the second axis AX2 with respect to the first arm Al. For example, the robot 1 may have a configuration in which the support D22 is caused to slide in the first frontward direction or the first rearward direction with respect to the first arm A1, and thereby it is possible to change the position of the second axis AX2 with respect to the first arm A1. In this case, for example, a rail is provided on the underside of the first arm A1 in the longitudinal direction of the first arm A1. The support D22 can be caused to slide along the rail and can be fixed to the rail with a bolt or the like. The robot may have a configuration in which, instead of the rail, another member that causes the support D22 to slide in the first frontward direction or the first rearward direction with respect to the first arm A1 is provided on the underside. In addition, the robot may have a configuration in which a mechanism unit that causes the support D22 to slide in the first frontward direction or the first rearward direction with respect to the first arm A1 is provided on the underside. In this case, the robot control device 30 performs controlling to drive the mechanism unit and causes the support D22 to slide in the first frontward direction or the first rearward direction with respect to the first arm A1.

FIG. 8 is a view illustrating an example of the robot 1 after the support D22 is caused to slide in the first frontward direction or the first rearward direction with respect to the first arm A1 in the robot 1 illustrated in FIG. 2. As illustrated in FIG. 8, in the robot 1, the support D22 is caused to slide in the first frontward direction or the first rearward direction with respect to the first arm A1, and thereby it is possible to change the position of the second axis AX2 with respect to the first arm A1. In this manner, in the robot 1, it is possible to change the thirteenth negative-direction distance. As a result, it is possible to change the movable range of the robot 1 into a range desired by a user. The robot may have a configuration obtained by combining a configuration in which it is possible to change the movable range of the robot 1 by changing the position of the second axis AX2 with respect to the second arm A2, and a configuration in which it is possible to change the movable range of the robot 1 by changing the position of the second axis AX2 with respect to the first arm A1.

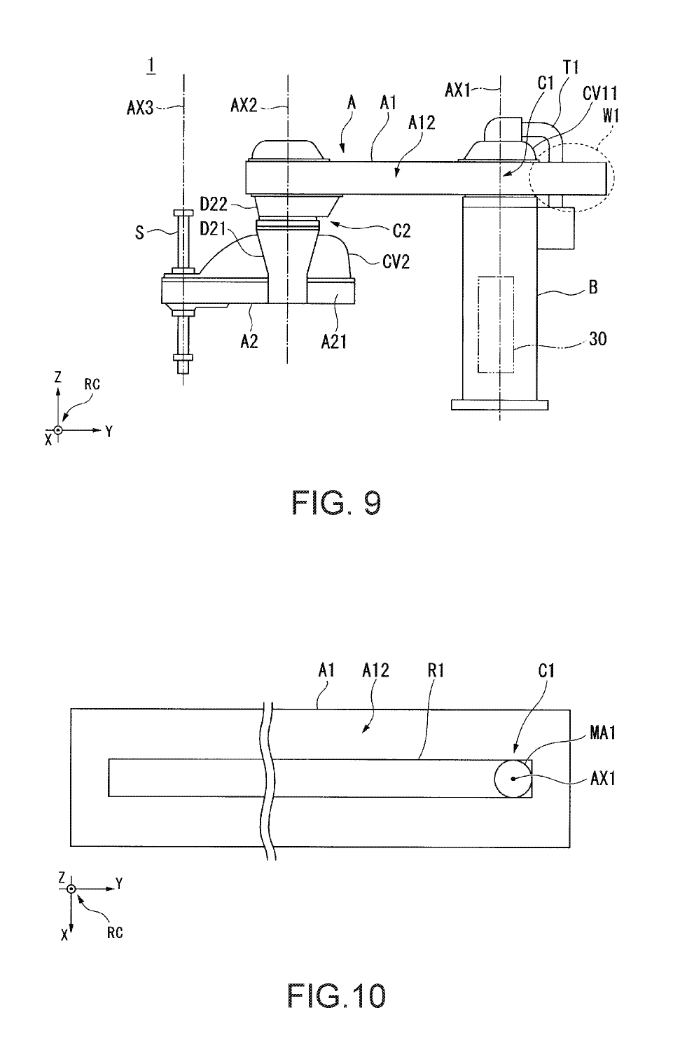

In addition, instead of a configuration in which it is possible to change the movable range of the robot 1 by changing the position of the second axis AX2 with respect to the second arm A2, the robot 1 may have a configuration in which it is possible to change the movable range of the robot 1 by changing the position of the first axis AX1 with respect to the first arm A1. FIG. 9 is a view illustrating an example of the robot 1 after the first arm A1 is caused to slide in the first rearward direction with respect to the first axis AX1 in the robot 1 illustrated in FIG. 2. In this case, as illustrated in FIG. 10, a rail R1 that penetrates through an arm member in the Z-axis direction in the robot coordinate system RC is formed in the arm member (for example, the arm member A11 or the arm member A12) of the first arm A1. FIG. 10 is a view illustrating an example of the first arm A1 including the arm member A12 on which the rail R1 is formed.

In an example illustrated in FIG. 10, the longitudinal direction of the arm member A12 matches a Y-axis direction in the robot coordinate system RC. In addition, a shaft MA1 as a rotary shaft of the motor 41 is inserted into the rail R1. In this case, the shaft MA1 can be caused to slide in the Y-axis direction. In addition, the shaft MA1 illustrated in FIG. 10 is provided with a through-hole that penetrates in an X-axis direction in the robot coordinate system. RC and passes through the center axis of the shaft MA1. In addition, the arm member A12 illustrated in FIG. 10 is provided with a plurality of through-holes that penetrates in the X-axis direction in the robot coordinate system RC at positions different from each other in the Y-axis direction. The shaft MA1 can be fixed to each of the positions. In other words, a rod member such as a pin is inserted through each of the though-hole formed in the shaft MA1 and one through-hole of the plurality of through-holes formed in the arm member A12 in the Y-axis direction, and thereby it is possible to fix the shaft MA1 to the arm member A12 at the position of the one through-hole. In this manner, it is possible for the user to change the position of the shaft MA1 to the arm member A12 to a position desired by the user and to fix the shaft thereto. In other words, in the robot 1, it is possible to change the position of the first axis AX1 with respect to the first arm A1. In the robot 1, the position of the first shaft AX1 is changed with respect to the first arm A1, and thereby it is possible to change the thirteenth positive-direction distance and the thirteenth negative-direction distance. As a result, it is possible to change the movable range of the robot 1 into a range desired by a user. Instead of the rotary shaft of the motor 41, the shaft MA1 illustrated in FIG. 10 may be an output shaft of a deceleration device that decelerates a rotating speed of the motor 41. In this case, the rotary shaft of the motor 41 is connected to the deceleration device.

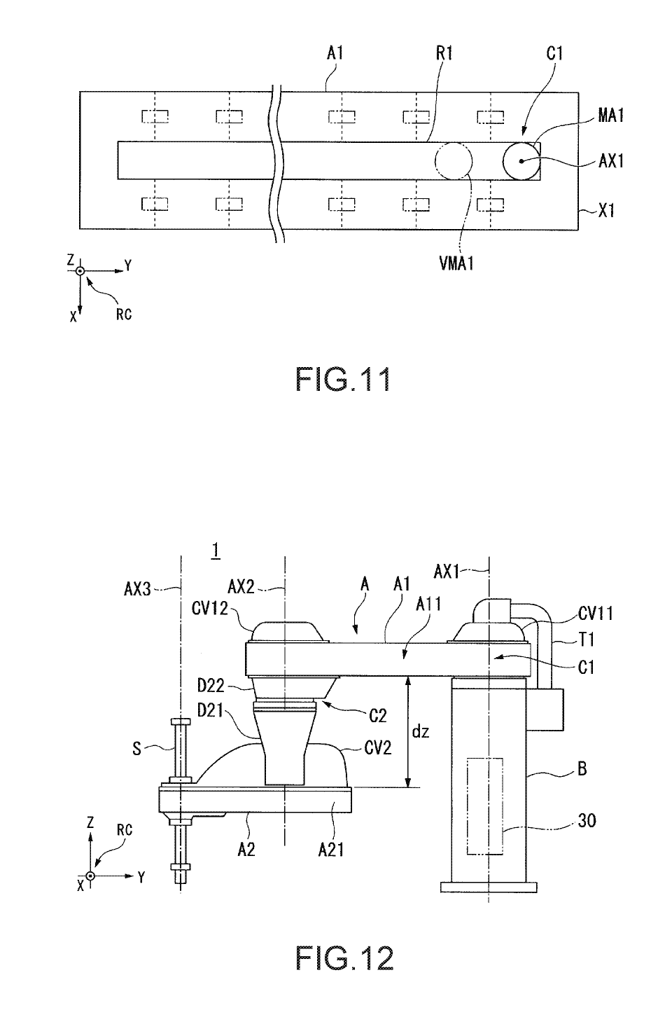

Here, in the robot 1, in a case where the position of the first axis AX1 is changed with respect to the first arm A1, a portion of the portions of the first arm A1 on a side in the first rearward direction may project in a side in the first rearward direction from a surface on the side in the first rearward direction of the surfaces of the base B. A portion of the first arm A1 as a portion surrounded by a dotted line W1 in FIG. 9 is an example of a portion that projects on the side in the first rearward direction from the surface on the side in the first rearward direction of the surfaces of the base B. In this case, the portion may interfere with another object other than the robot 1. In order to reduce an occurrence of the interference of the portion with the object, the arm member of the first arm A1 may be configured to be disassembled into a plurality of members in the longitudinal direction of the arm member as illustrated in FIG. 11. FIG. 11 is a view illustrating an example of an arm member of the first arm A1, and the arm member can be disassembled into a plurality of members in the longitudinal direction. A dotted line in FIG. 11 represents a boundary line between the plurality of members that configure the arm member. In addition, rectangular shapes in two-dot chain lines in FIG. 11 represent connecting members such as bolts that connect the plurality of members to each other. For example, in a case where a user fixes the shaft MA1 at a position at which an outline of the shaft MA1 is coincident with an outline represented a circle VMA1, in the robot 1, one member X1 of the plurality of members is detached from the arm member, and thereby it is possible to remove a portion projecting to the side in the first rearward direction from the surface on the side in the first rearward direction of the surfaces of the base B. As a result, in the robot 1, it is possible to reduce the occurrence of a case where the portion is likely to interfere with the object.

In addition, the robot may have a configuration in which, when the user changes the position of the second axis AX2 with respect to the second arm A2, the connecting portion C2 causes the second arm A2 to slide upward or downward along the second axis AX2. FIG. 12 is a view illustrating an example of the robot 1 after the second arm A2 is caused to slide downward along the second axis AX2 in the robot 1 illustrated in FIG. 1. In this case, for example, the second arm A2 (in an example illustrated in FIG. 12, the cover CV2) is provided with a plurality of screw holes aligned in the vertical direction. The second arm A2 can be caused to slide along the screw hole, and the second arm A2 can be fixed to the pinching portion D21 with the screw hole and a bolt. In other words, in the robot 1 illustrated in FIG. 12, it is possible to change the distance dz described above. The robot may have a configuration in which, instead of the screw hole, the rail, or the like, the second arm A2 is provided with another member that causes the second arm A2 to slide upward or downward along the second axis AX2 may be employed. In addition, the robot may have a configuration in which the second arm A2 is provided with a mechanism unit that causes the second arm A2 to slide upward or downward along the second axis AX2. In this case, the robot control device 30 performs controlling to drive the mechanism unit and causes the second arm A2 to slide upward or downward along the second axis AX2.

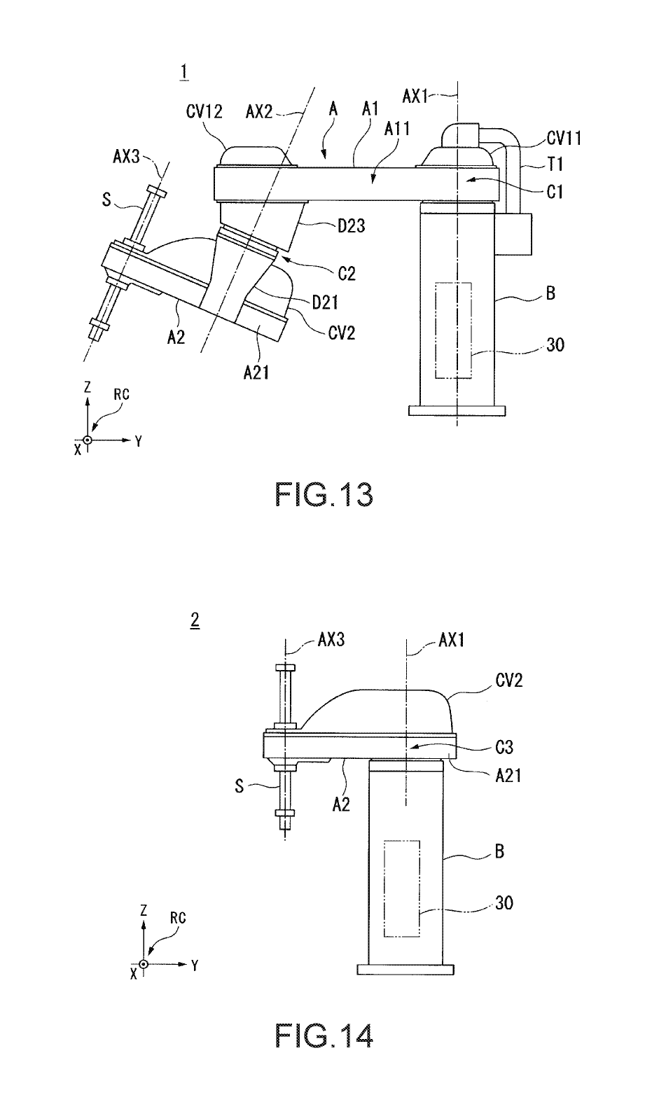

In addition, the robot may have a configuration in which, when the user changes the position of the second axis AX2 with respect to the second arm A2, the connecting portion C2 causes the second arm A2 to rotate around the second axis AX2. FIG. 13 is a view illustrating an example of the robot 1 after the second arm A2 is caused to rotate around the second axis AX2 in the robot 1 illustrated in FIG. 1. In this case, for example, the robot 1 includes a support D23 instead of the support D22. The support D23 supports the pinching portion D21. In addition, the support D23 includes the motor 42. A surface, on which the pinching portion D21 is provided, of the surfaces of the support D23 is inclined with respect to the underside of the first arm A1. In an example illustrated in FIG. 13, the surface is inclined with respect to the underside such that the second axis AX2 and the first axis AX1 intersect with each other above the first arm A1. In other words, the user replaces the support D22 of the robot 1 illustrated in FIG. 1 with the support D23 illustrated in FIG. 13, and thereby it is possible to change the position of the second axis AX2 with respect to the second arm A2. Here, in a case where the support D22 is replaced with the support D23, the user replaces the motor 42. The robot 1 illustrated in FIG. 13 may have a configuration in which the support D23 is provided to be rotatable with respect to the first arm A1 around an axis parallel to the X axis in the robot coordinate system RC illustrated in FIG. 13. In this case, the support D23 rotates along with the motor 42 included in the support D23 around the axis with respect to the first arm A1. Such a support D23 may manually rotate or may rotate through controlling by the robot control device 30.

As described above, in the robot 1, it is possible to change the position of the second axis AX2 with respect to at least one of the second arm A2 and the first arm A1 which relatively rotate around the second axis AX2, and it is possible to change the position of the first axis AX1 with respect to at least one of the first arm A1 and the base B which relatively rotate around the second axis AX2. The robot 1 may have a configuration in which it is possible to change at least one of the position of the second axis AX2 with respect to at least one of the second arm A2 and the first arm A1, which relatively rotate around the second axis AX2, and the position of the first axis AX1 with respect to at least one of the first arm A1 and the base B, which relatively rotate around the second axis AX2.

In addition, the robot 1 may be configured to have one arm, that is, only the first arm. FIG. 14 is a view illustrating an example of a robot 2 including only one arm. Specifically, the robot 2 is a robot which does not include the first arm A1 that is omitted from the robot 1 illustrated in FIG. 1, and in which the second arm A2 is supported by the base B to be rotatable around the first axis AX1.

In addition, a connecting portion C3 that connects the base B and the second arm A2 is provided at an end portion on the side of the base B (that is, the side in the second rearward direction) of the end portions of the second arm A2 illustrated in FIG. 14. In FIG. 14, only the position of the connecting portion C3 is illustrated due to the simplification of FIG. 1. For example, the connecting portion C3 mechanically connects the rotary shaft of the motor 41 and the second arm A2 with a bolt. Instead, the connecting portion C3 may be configured to connect the rotary shaft and the second arm A2 by another method.

For example, in the robot 2, it is possible to change the position of the first axis AX1 with respect to the second arm A2 by the method described in FIG. 9. In this manner, in the robot 2, even in a case where only one arm is provided, it is possible to change a movable range into a range desired by a user.

In a case where the robot 1 described above is a vertical articulated robot having six or more axes, each of one or more bending joints included in the vertical articulated robot changes the position of the rotary shaft of the bending joint with respect to at least one of the two members connected to the bending joint in the vertical articulated robot, and thereby it is possible to change the movable range of the vertical articulated robot into a movable range desired by the user.

As described above, in the robot 1 (or the robot 2), it is possible to change the position of the rotary shaft for at least one of the two members that relatively rotate around the rotary shaft in the robot 1 (or the robot 2). In addition, the robot 1 (or the robot 2) includes the two members, and the two members that relatively rotate around a rotary shaft are the assembly of an arm and a base or the assembly of an arm and an arm in the robot 1 (or the robot 2). Specifically, as described above, in the robot 1, it is possible to change the position of the rotary shaft with respect to at least one of the assembly (in the example described above, the assembly of the first arm A1 and the second arm A2) of an arm and another arm which relatively rotate around a certain rotary shaft (in the example described above, the second axis AX2). In addition, in the robot 1, it is possible to change the position of the rotary shaft with respect to at least one of the assembly of an arm and a base (in the example described above, the assembly of the first arm A1 and the base B) which relatively rotate around a certain rotary shaft (in the example described above, the first axis AX1). In addition, in the robot 2, it is possible to change the position of the rotary shaft with respect to at least one of the assembly of an arm and a base (in the example described above, the assembly of the second arm A2 and the base B) which relatively rotate around a certain rotary shaft (in the example described above, the first axis AX1). As described above, in the robot (the robot 2), the position of the rotary shaft with respect to at least one member in the assembly of the arm and the base or at least one member in the assembly of the arm and arm is changed, and thereby it is possible to change the movable range into a range desired by a user.

In addition, in the robot 1, a predetermined position (in the example described above, the position of the second arm A2, at which the shaft S is provided) of one of the two arms (in the example described above, the first arm A1 and the second arm A2) passes above or below the other member such that the arms rotate with respect to each other when viewed in an axial direction (for example, the first viewpoint described above) of the rotary shaft (in the example described above, the second axis AX2). In this manner, in the robot 1, it is possible to perform work depending on actuation desired by a user.

In addition, in the robot 1 (or the robot 2), the robot 1 includes the two members and the connecting portion (in the example described above, each of the connecting portion C1 and connecting potion C2) that connects the two members which relatively rotate around the rotary shaft is provided, the connecting position between at least one of the two members and the connecting portion can be changed. In this manner, the robot 1 includes the two members, in the robot 1, the connecting position between the connecting portion and at least one of the two members that relatively rotate around the rotary shaft is changed, and thereby it is possible to change the movable range into a range desired by a user.

In addition, in the robot 1, the second arm A2 is provided on a side of an installation surface of the base B with respect to the first arm A1 in the axial direction of the second axis AX2. In this manner, in the robot 1, it is possible to reduce the size of the robot 1.

In addition, in the robot 1, the robot control device 30 is provided in the base B and controls the robot 1. In this manner, in the robot 1, it is possible to reduce an occupation area of a range in which the robot 1 is installed, compared to a case where the robot control device 30 is provided outside the base B.

### Layout of Wiring of Robot

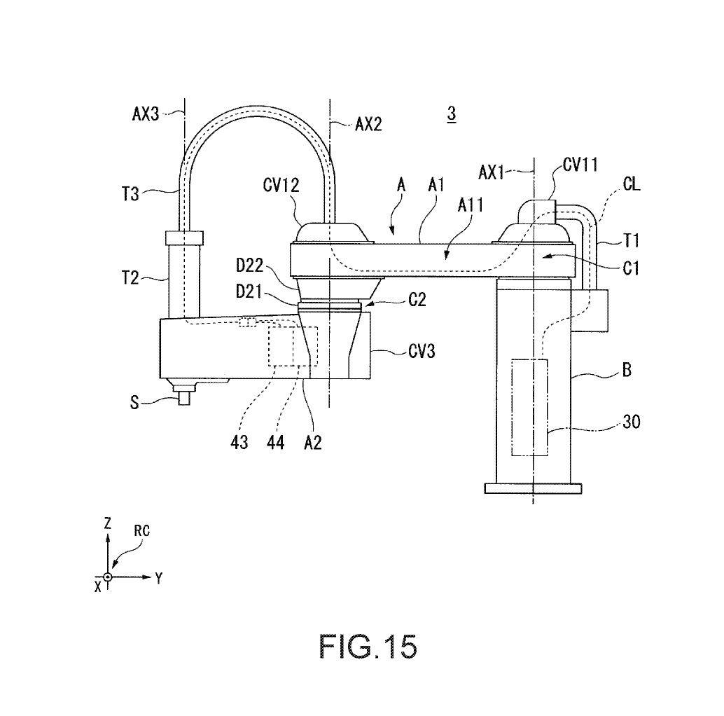

Hereinafter, a layout of wiring of the robot 1 will be described with reference to FIGS. 15 to 17. In the robot 1 illustrated in FIG. 1, at least a part of the layout of the wiring from the robot control device 30 to the motors in the robot 1 is performed inside the connecting portion C2, that is, inside the second arm A2 through a space between the motor 42 and an inner wall of the support D22, that is, inside the cover CV2. Specifically, layout of various types of wiring that are connected to each of the motors 43 and 44 disposed inside the second arm A2 is performed from the inside of the connecting portion C2 to the inside of the cover CV2 through the space between the motor 42 and the inner wall. As described above, a layout method of various types of wiring through the space between the motor and the inner wall of the member, in which the motor is installed, is not limited to the application to the robot 1 illustrated in FIG. 1, but is employed in at least apart of the robot (for example, the robot in the related art) that is different from the robot 1.

However, in a case where the layout of the wiring is performed through the space between the motor and the inner wall of the member, in which the motor is installed, the wiring is highly likely to have a problem due to heat of the motor when the wiring comes into contact with the motor. In order to reduce the occurrence of the problem of the wiring, there is a method of reducing an amount of heat generation of the motor. However, in this method, the manufacturing costs of the robot are likely to increase. In addition, in this case, the wiring may be disconnected due to contact of the wiring with another object. The other object includes the inner wall.

For example, in order to reduce the occurrence of the problem, as illustrated in FIG. 15, instead of the configuration in which the layout of the various types of wiring is performed from the inside the connecting portion C2 to the inside of the cover CV2 through the space between the motor 42 and the inner wall of the support D22, the robot 1 may have a configuration in which the layout of the wiring is performed in this order from the inside of the first arm A1, the insides of a tube T3 and a cylindrical portion T2 illustrated in FIG. 15 to the inside of the cover CV2. Here, FIG. 15 is a view illustrating an example of a configuration of a robot 3. The robot 3 is a robot that includes the cylindrical portion T2 inserted into the through-hole, instead of a cover CV3 provided with a through-hole that penetrates through the cover CV2 in a direction along the third axis AX3 in the robot 1 illustrated in FIG. 1.

In an example thereof, there is a gap between the lower end portion of the cylindrical portion T2 and the top surface of the arm member A21. In other words, the cylindrical portion T2 is fixed to the through-hole provided in the cover CV3. In addition, the second arm A2 is provided with the cylindrical portion T2 such that the central axis of the cylindrical portion T2 matches the third axis AX3. The cylindrical portion T2 is provided with one or more through-holes that penetrate through the cylindrical portion T2 along the central axis. In addition, the shaft S is inserted into one of the through-holes.

In addition, in the robot 3, a cover CV12 is provided with a hole through which the wiring layout from the inside of the first arm A1 is drawn out to the outside of the first arm A1. The tube T3 that connects the hole and the upper end portion of the cylindrical portion T2 is provided in the hole and on the upper end portion of the cylindrical portion T2. In this manner, in the robot 3, the layout of various types of wiring that are connected from the robot control device 30 to each of the motors 43 and 44 is performed in this order from the inside of the base B, the insides of the tube T1 and the first arm A1, the tube T3, and the cylindrical portion T2, to the inside of the cover CV2. A line CL in FIG. 15 represents a path of the wiring layout in the robot 3.

Examples of the various types of wiring that is connected from the robot control device 30 to each of the motors 43 and 44 in the robot 3 include a power line through which power is supplied to each of the motors 43 and 44 and a signal line through which a control signal that controls each of the motors 43 and 44 is transmitted. The robot may have a configuration in which the wiring may include other wiring such as a power line through which power is supplied to an end effector or a signal line through which a control signal that controls the end effector is transmitted.

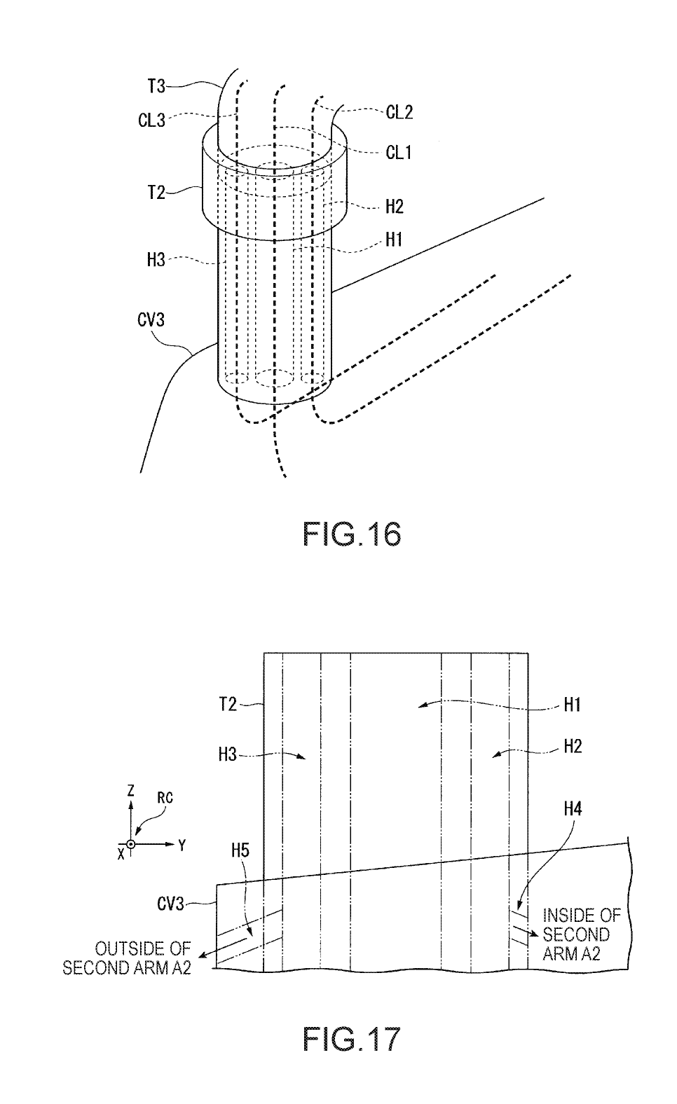

Here, FIG. 16 is a perspective view illustrating an example of an internal structure of the cylindrical portion T2. In the example illustrated in FIG. 16, the cylindrical portion T2 is provided with each of three through-holes of through-holes H1 to H3. The cylindrical portion T2 may be configured to have two or less through-holes instead of three through-holes or may be configured to have four or more through-holes.

In addition, the through-hole H1 is a through-hole formed in the cylindrical portion T2 such that the central axis of the through-hole H1 matches the third axis AX3. As described above, the shaft S is inserted into the through-hole H1. In FIG. 16, the shaft S is omitted due to the simplification of FIG. 16. The through-hole H1 has an inner diameter larger than an outer diameter of the upper end portion of the shaft S. In the robot 3, the shaft S is provided with through-holes along the central axis of the shaft S. The through-holes are through-holes through which various types of wiring CL1 that is connected to the end effector are inserted. In other words, in a case where the robot 3 includes the end effector, the user can connect various types of wiring connected to the end effector from a control device which controls the end effector, through the inside of the first arm A1, the tube T3, and the through-hole in this order to the end effector. Instead of the wiring that is connected from the control device to the end effector, the wiring may be other wiring such as wiring that is connected to an imaging unit from a control device that controls the imaging unit or wiring that is connected to the sensor from a control device that controls various types of sensors such as a force sensor.

The through-hole H2 is a through-hole into which signal lines that are connected from the robot control device 30 to each of the motor 43 and motor 44 are inserted. In an example thereof, an inner diameter of the through-hole H2 is smaller than the inner diameter of the through-hole H1. The inner diameter of the through-hole H2 may be equal to or larger than the inner diameter of the through-hole H1. Each of the signal lines that are connected from the robot control device 30 to each of the motor 43 and motor 44 can be connected by a user through the inside of the first arm A1, the tube T3, and the through-hole H2 in this order to each of the motors 43 and 44. Instead of the signal line, the wiring that is inserted into the through-hole H2 may be other wiring such as power lines that are connected from the robot control device 30 to each of the motor 43 and motor 44.

The through-hole H3 is a through-hole into which power lines that are connected from the robot control device 30 to each of the motor 43 and motor 44 are inserted. In an example thereof, an inner diameter of the through-hole H3 is smaller than the inner diameter of the through-hole H1. The inner diameter of the through-hole H3 may be equal to or larger than the inner diameter of the through-hole H1. Each of the power lines that are connected from the robot control device 30 to each of the motor 43 and motor 44 can be connected by a user through the inside of the first arm A1, the tube T3, and the through-hole H3 in this order to each of the motors 43 and 44. Instead of the power lines, the wiring that is inserted into the through-hole H3 may be other wiring such as signal lines that are connected from the robot control device 30 to each of the motor 43 and motor 44.

The through-hole H2 and the through-hole H3 may have different inner diameter from each other or may have the same inner diameter as each other. In the example illustrated in FIG. 16, the through-hole H2 and the through-hole H3 have the same inner diameter as each other.

Here, in the robot 3, it is desirable that the central axes of the through-holes H1 to H3 are aligned in the second frontward direction. In this manner, the robot 3 can reduce vibration or the like based on an inertia moment of the second arm A2 and stabilize the actuation of the second arm A2. In a case where two, four, or more through-holes are formed in the cylindrical portion T2, the central axes of the through-holes are arranged in a positional relationship corresponding to the number of the through-holes, and thereby it is possible to reduce vibration or the like based on an inertia moment of the second arm A2 and to stabilize the actuation of the second arm A2. In the robot 3, the central axes of the through-holes H1 to H3 may not be aligned in the second frontward direction.

As described above, in the robot 3, the cylindrical portion T2 is provided with through-holes corresponding to the types of wiring in the robot 3. In this manner, in the robot 3, it is possible to reduce an occurrence of intertwinement of the wiring. In addition, in the robot 3, the user checks which hole formed in the cylindrical portion T2 the layout of the wiring is performed from, and thereby it is possible to reduce the occurrence of misconnection of the wiring.

In other words, in the robot 3, through at least a portion of second through-holes (in the example described above, each of the through-holes H2 and H3) which are one or more through-holes different from the first through-hole (in the example described above, the through-hole H1) of the plurality of through-holes that penetrate through the second arm A2 (in the example described above, the cylindrical portion T2 provided in the second arm A2), the layout of the wiring (in the example described above, each of the power supply line and signal line), which is connected to the drive unit (in the example described above, each of the motors 43 and 44) is performed. In this manner, in the robot 3, it is possible to reduce the occurrence of disconnection of the wiring, compared to a case where wiring is connected to a drive unit through a portion (in the example described above, the inside of the connecting portion C2) of a joint between the first arm A1 and the second arm A2.

In addition, in a robot (for example, a robot in the related art) that is different from the robot 3, in a case where the layout of various types of wiring is performed to the inside of the second arm A2 through the inside of the connecting portion C2, a portion of a space between the motor 42 and the inner wall of the support D22 needs to be increased to the extent that the wiring passes therethrough. However, in the robot 3, since the wiring does not pass through the portion, it is possible to reduce the portion. As a result, it is possible to reduce amounts of an increase in manufacturing costs, an increase in range in which the wiring comes into contact with the robot 3 while the robot is actuated, an increase in weight, and an increase in size of the robot 3.

In addition, in the robot 3, it is possible to perform the layout of the various types of wiring that are connected to a desired device that is desired to be provided in the robot 3 by the user of the various types of wiring that are connected to the end effector or the like through the same path as that of the wiring for driving the robot 3 (in the example described above, each of the power line and the signal line that are connected to each of the motors 43 and 44). In this manner, the user can prevent the wiring from intertwining while the layout of the various types wiring that are connected to the end effector and the wiring for driving the robot 3 is performed through substantially the same path.

The robot 3 may have a configuration in which, through the through-hole H2 described above (that is, the through-hole, into which the shaft S is not inserted, of the through-holes formed in the cylindrical portion T2), the second arm A2 is provided with a through-hole which is connected to the through-hole H2 in a direction in the second arm A2 which intersects with the direction along the central axis of the shaft S. In addition, the robot 3 may have a configuration in which, through the through-hole H3 described above (that is, the through-hole, into which the shaft S is not inserted, of the through-holes formed in the cylindrical portion T2), the second arm A2 is provided with a through-hole which is connected to the through-hole H3 in a direction in the second arm A2 which intersects with the direction along the central axis of the shaft S. Hereinafter, for convenience of description, the through-hole is referred to as a horizontal through-hole. FIG. 17 is a view illustrating an example of the second arm A2 in which the horizontal through-holes are formed. The corresponding direction is an example of the axis direction of the actuation shaft.

In an example thereof, in the robot 3, there is no gap between the lower end portion of the cylindrical portion T2 and the top surface of the arm member A21. In other words, the cylindrical portion T2 is fixed to the arm member A21. The robot 3 may have a configuration in which there is a gap between the lower end portion of the cylindrical portion T2 and the top surface of the arm member A21. Here, in an example illustrated in FIG. 17, the second frontward direction matches a negative direction of the Y-axis direction in the robot coordinate system RC.

In the example illustrated in FIG. 17, a horizontal through-hole H4, which connects the through-hole H2 and the inside of the cover CV3, and a horizontal through-hole H5, which connects the through-hole H3 and the outside of the cover CV3 are formed in the cylindrical portion T2 in a direction intersecting with a direction along the third axis AX3 (that is, the direction along the central axis of the shaft S). In FIG. 17, the horizontal through-hole H4 is formed in the cylindrical portion T2 in a direction inclined with respect to the Y axis in the robot coordinate system RC; however, this is only an example, and a configuration in which the horizontal through-hole H4 is formed in a direction along the Y axis may be employed. In addition, in FIG. 17, the horizontal through-hole H5 is formed in the cylindrical portion T2 in a direction inclined with respect to the Y axis in the robot coordinate system RC; however, this is only an example, and a configuration in which the horizontal through-hole H5 is formed in a direction along the Y axis may be employed.

By using the formed horizontal through-hole H4, each of the signal lines that are connected from the robot control device 30 to each of the motor 43 and motor 44 can be connected by a user through the inside of the first arm A1, the tube T3, the through-hole H2, and the horizontal through-hole H4 in this order to each of the motors 43 and 44. In this case, each of the power lines that are connected from the robot control device 30 to each of the motor 43 and motor 44 can be connected by a user through the inside of the first arm A1, the tube T3, the through-hole H2, and the horizontal through-hole H4 in this order to each of the motors 43 and 44.

In addition, by using the horizontal through-hole H5, the various types of wiring that are connected to the end effector from the robot control device 30 can be connected by the user through the inside of the first arm A1, the tube T3, the through-hole H3, the horizontal through-hole H5 and the outside of the second arm A2 in this order to the end effector. As a result, in the robot 3, the wiring does not need to pass through the through-hole formed in the shaft S by the user. As a result, in the robot 3, it is possible to reduce an occurrence of wear, disconnection, or the like of the wiring due to the actuation of the shaft S.

As described above, in the robot 3, through a portion or all of one or more second through-holes (in the example described above, the through-holes H2 and H3) in the second arm A2, the second arm A2 is provided with the third through-hole (in the example described above, each of the horizontal through-holes H4 and H5) which is connected to the second through-hole in a direction intersecting with the axial direction of the actuation shaft (in the example described above, the shaft S). In this manner, in the robot 3, it is possible to connect the wiring to a device that is desired by a user through the horizontal through-hole.

In addition, in the robot 3, the wiring that is connected to the end effector provided on the shaft S passes through the horizontal through-hole (in the example described above, the horizontal through-hole H5). In this manner, in the robot 3, it is possible to reduce the portion of the layout of the wiring to an outer circumferential portion of the robot of the wiring connected to the end effector. As a result, in the robot 3, it is possible to reduce the occurrence of the disconnection of the wiring that is connected to the end effector.

Base Included in Robot

Hereinafter, the base B of the robot 1 will be described. In a case where the robot control device 30 is internally installed to the robot 1, an attachment portion provided with various types of ports that connect the various types of wiring for connecting another device to the robot control device 30 installed in the robot 1, is attached to the base B. In addition, in a case where the robot control device 30 is externally installed in the robot 1, an attachment portion provided with various types of ports that connect the various types of wiring for connecting the robot 1 and the robot control device 30, is attached to the base B.

In a robot (for example, a robot in the related art) different from the robot 1, the attachment portion is often provided at any position of the back surface as a surface that is most separated from a working region of the robot of the underside of the base or the surfaces of the base included in the robot. Here, in a case where a surface of the base, to which the attachment portion is attached, of the surfaces of the base is changed to another surface of the base in the robot, a new member needs to be attached to the base in some cases. As a result, in the robot, it is difficult for the user to change the surface of the base, to which the attachment portion is attached, of the surfaces of the base to another surface of the base in the robot at a desired timing for the user in some cases. In addition, a manufacturer that manufactures the robot needs to individually manufacture the base and the member as desired by the user. As a result, the manufacturing costs, an inventory volume, and the like of the robot are increased in some cases.

In order to reduce the occurrence of such problems, in the robot 1 in an example thereof, the base B includes an attachment portion L1 that enables an object to be attached to two or more sites different from each other of the sites of the base B. In this manner, in the robot 1, it is possible to attach the object, which is desired by a user, to the site, which is desired by a user. Hereinafter, for convenience of description, the base B including the attachment portion L1 is referred to as a base BB. In addition, in the robot 1, a port PT, to which the wiring is connected, is provided as the object on the attachment portion L1. In this manner, in the robot 1, there is no need to manufacture an additional member that is attached to the base BB in order to change the position of the base BB to which the port is attached as desired by the user, and thus it is possible to reduce the amounts of an increase in manufacturing costs and an increase in inventory volume. The robot 1 may have a configuration in which, instead of the port PT to which the wiring is connected, a movable portion A is provided as the object to an attachment portion L1. In this case, in the robot 1, it is possible to attach the movable portion A to the site of the base BB, which is desired by a user. In addition, the robot 1 may have a configuration in which both of the port PT and the movable portion A are provided as the objects to the attachment portion L1. In this case, the attachment portion L1 may have both of a portion, to which the port PT is provided, and a portion, to which the movable portion A is attached, separately or may have the portions integrally.

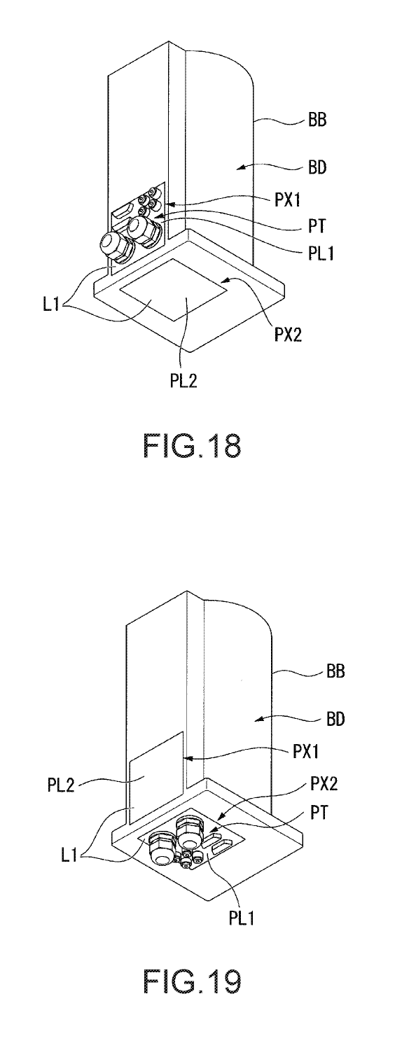

Hereinafter, a specific example of a configuration of the base BB will be described with reference to FIGS. 18 to 28. Here, In FIGS. 18 to 28, the tube T1 is omitted due to the simplification of FIGS. 18 to 28. FIG. 18 is a view illustrating an example of the configuration of the base BB. For example, the base BB includes the attachment portion L1, to which the port PT is provided, and a housing BD provided with a site PX1 and a site PX2 as two sites to which the attachment portion L1 is attachable. For example, the attachment portion L1 is configured to have a member PL1 and a member PL2 which are two flat plates separated from each other and flat plates having a square shape. The members PL1 and PL2 are flat plates having the same shape as each other. Each of the member PL1 and the member PL2 may be a flat plat having a rectangular shape, a circular shape, an elliptical shape, or the like or may be a curved plate instead of the rectangular shape. In the example illustrated in FIG. 18, the port PT is provided on the member PL1. The port PT may be configured to be provided on the member PL2. In addition, in this example, the site PX2 is formed on the underside of the housing BD, and the site PX1 is formed on the back surface (surface, on which the tube T1 is provided, of the surfaces of the base B) of the surfaces of the housing BD. In other words, in this example, the member PL2 is attached on the underside and the member PL1 is attached on the back surface. In an example thereof, the member PTL1 is attached to the site PX1 with a screw, a bolt, or the like, and the member PTL2 is attached to the site PX2 with a screw, a bolt, or the like. The member PL1 may be configured to be attached to the PX1 through another method of attachment by a pushpin to the site PX1, and the member PL2 may be configured to be attached to the PX2 through another method of attachment by a pushpin to the site PX2. Here, the method of attaching the member PL1 to the site PX1 and the method of attaching the member PL2 to the site PX2 are the same method.

The user can attach the member PL1 to any one of the site PX1 and the site PX2 and attach the member PL2 to the other site depending on a place where the robot 1 is installed. In other words, the user can switch between the members PL1 and PL2 depending on the place where the robot 1 is installed. FIG. 19 is a view illustrating an example of a state in which the member PL1 is attached on the underside of the housing BD and the member PL2 is attached on the back surface of the housing BD. As described above, in the robot 1, the port PT is attachable to two sites different from each other of the sites of the base BB. In this manner, in the robot 1, it is possible to attach the port PT to the site, which is desired by the user.

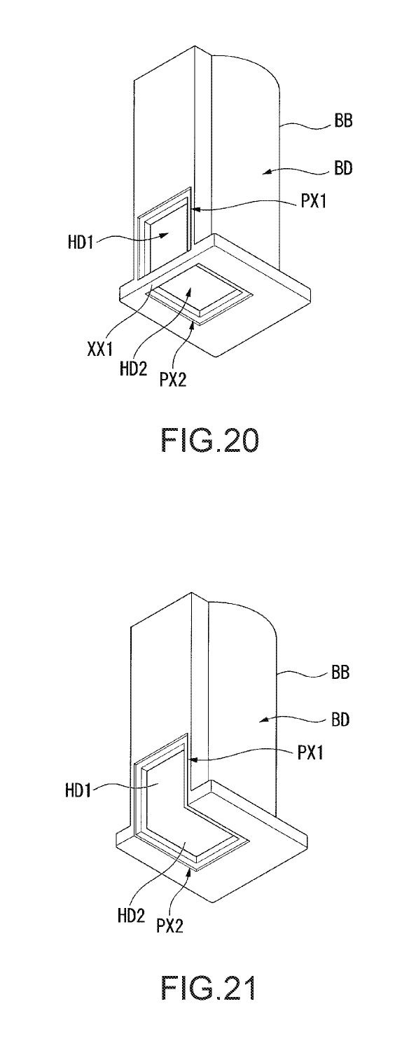

FIG. 20 is a view illustrating an example of the housing BD from which the members PL1 and PL2 are detached. As illustrated in FIG. 20, in the housing BD, the site PX1 is provided with an opening HD1 that is an opening to which each of the members PL1 and PL2 is attachable, and the site PX2 is provided with an opening HD2 that is an opening to which each of the members PL1 and PL2 is attachable. In an example illustrated in FIG. 20, in the housing BD, a partition XX1 that partitions the opening into the openings HD1 and HD2 is formed in the housing BD. In an example thereof, the partition XX1 is a part of the housing BD. In this case, the user detaches, from the port PT, the wiring laid from the port PT to the inside of the housing BD, and thereby it is possible to change a position at which the attachment portion L1 is attached. Instead, the partition XX1 may be a separate object from the housing BD. In addition, the housing BD may have a configuration in which the partition XX1 that partitions the opening into the openings HD1 and HD2 is not formed in the housing BD. In other words, the openings HD1 and HD2 may be connected to each other. FIG. 21 is a view illustrating an example of the housing BD in which the partition XX1 illustrated in FIG. 20 is omitted. In this case, the user can change the position at which the attachment portion L1 is attached without detaching, from the port PT, the wiring laid from the port PT to the inside of the housing BD. In other words, in the robot 1, the user can easily change the position of the attachment portion L1.

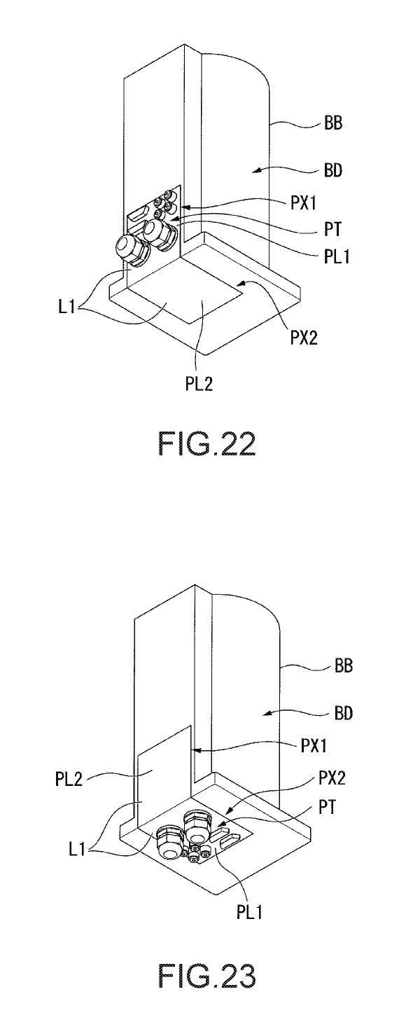

In a case where the partition XX1 is not formed in the housing BD, as illustrated in FIGS. 22 and 23, the attachment portion L1 may be an L-shaped member as one member formed by bonding the members PL1 and PL2 into an L shape. FIG. 22 is a view illustrating an example of the housing BD to which the L-shaped member is attached such that the member PL1 blocks the opening HD1. FIG. 23 is a view illustrating an example of the housing BD to which the L-shaped member is attached such that the member PL1 blocks the opening HD2. In such cases, as illustrated in FIGS. 22 and 23, an orientation of the L-shaped member is changed such that the positions of the members PL1 and PL2 bonded as the L-shaped member are switched, and thereby the user can change the site of the base BB to which the port PT is attached. In other words, in the robot 1, it is possible to attach the port PT to the site, which is desired by the user.

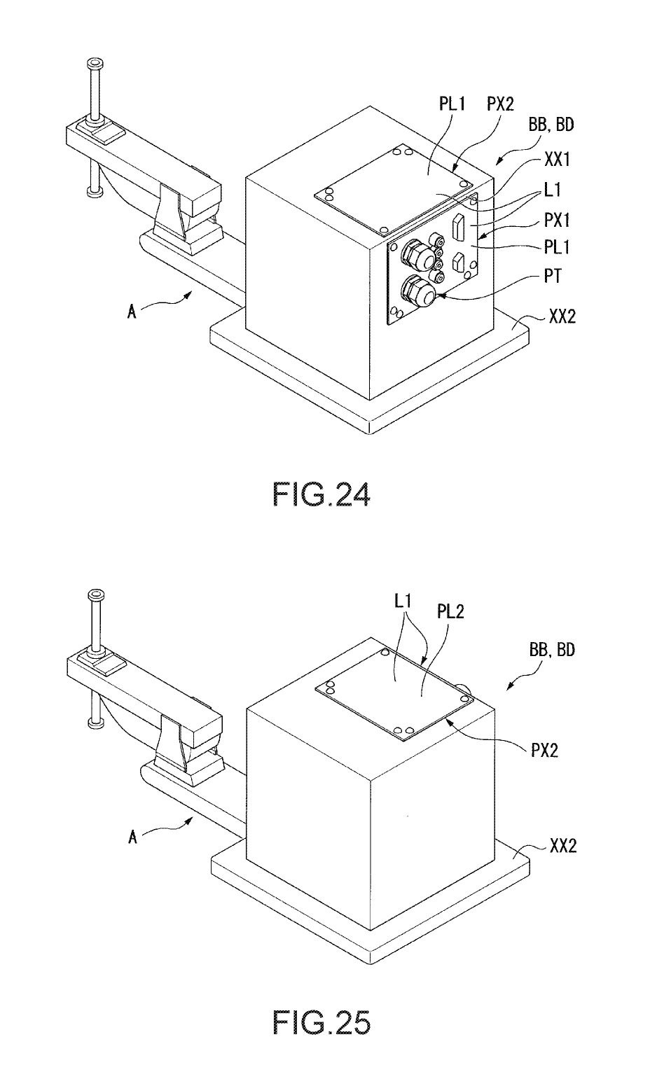

In addition, as illustrated in FIG. 24, the attachment portion L1 may be a box-shaped member that is one member having a box shape in which the member PL1 is bonded to an edge of the edges of a flat plate having a square shape orthogonal to the members PL1 and PL2, and the member PL2 is bonded to an edge facing the edge to which the member PL1 is bonded of the edges of the flat plate. FIG. 24 is a view illustrating an example of the base BB in a case where the attachment portion L1 is the box-shaped member. Here, a surface of the flat plate on a side opposite to a direction, in which each of the members PL1 and PL2 projects, of the surfaces thereof is the underside of the box-shaped member. In addition, in this case, the box-shaped member has an attachment portion on any one of the four side surfaces of the box-shaped member and the tube T1 is attachable to the attachment portion. In FIG. 24, the tube T1 and the attachment portion are omitted due to the simplification of FIG. 24. In addition, in this case, the housing BD includes the box-shaped member and a flat plate XX2 to which the box-shaped member is provided such that the top surface which is a surface (surface that is not blocked by the flat plate) of the box-shaped member on the side opposite to the underside is blocked. The movable portion A is provided (supported) on a surface on the side opposite to the surface of the flat plate XX2, on which the box-shaped member is provided, of the surfaces of the flat plate. In addition, in this case, the opening HD2 is formed in the underside of the box-shaped member, and the opening HD1 is formed in one surface of the side surfaces of the box-shaped member.

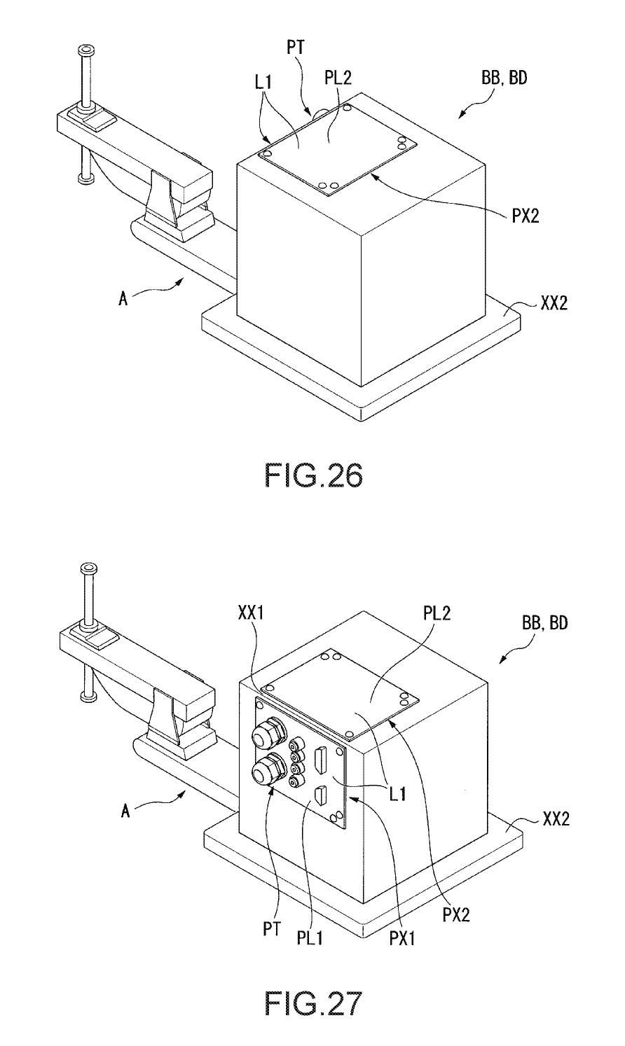

As illustrated in FIGS. 25 to 27, in a case where the box-shaped member is viewed from a viewpoint opposite to the first viewpoint, the box-shaped member is caused to rotate clockwise or counterclockwise around the center of the underside of the box-shaped member with respect to the flat plate XX2, and thereby the user can change the position at which the port PT is attached to the base BB. In other words, in the robot 1, it is possible to attach the port PT at a position, which is desired by the user. FIG. 25 is a view illustrating an example of the base BB in a case where the box-shaped member illustrated in FIG. 24 is caused to rotate counterclockwise by 90° with respect to the flat plate XX2 in a case where the base BB is viewed from a viewpoint opposite to the first viewpoint. FIG. 26 is a view illustrating an example of the base BB in a case where the box-shaped member illustrated in FIG. 24 is caused to rotate counterclockwise by 180° with respect to the flat plate XX2 in a case where the base BB is viewed from a viewpoint opposite to the first viewpoint. FIG. 27 is a view illustrating an example of the base BB in a case where the box-shaped member illustrated in FIG. 24 is caused to rotate counterclockwise by 270° with respect to the flat plate XX2 in a case where the base BB is viewed in a direction from the underside to the top surface of the box-shaped member. The robot may have a configuration in which it is possible for the user to rotate the box-shaped member illustrated in FIG. 24 counterclockwise by any angle with respect to the flat plate XX2 in a case where the base BB is viewed from a viewpoint. In this case, it is desirable that the box-shaped member has a cylindrical shape instead of the box-shape.

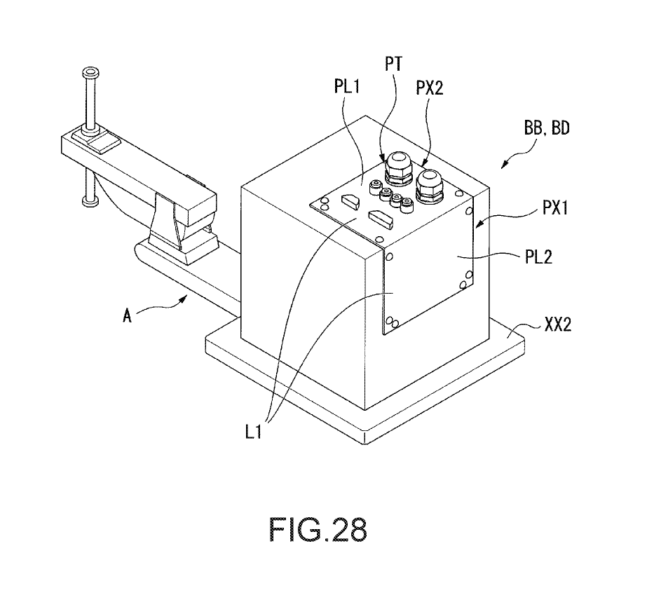

In addition, the L-shaped member illustrated in FIGS. 22 and 23 and the box-shaped members illustrated in FIGS. 24 to 27 are combined, and thereby it is possible to attach the port PT to the underside of the box-shaped member, that is, the underside of the base BB in the robot 1. FIG. 28 is a view illustrating an example of a case of the base BB in which the port PT is attached to the underside of the base BB illustrated in FIG. 24. In this case, as illustrated in FIG. 28, the partition XX1 is formed in the housing BD.

The robot 1 may have a configuration in which the attachment portion that enables the port PT to be attached to three or more sites different from each other of the base BB. In addition, the robot 1 may have a configuration in which each of the port PT and the movable portion A is attachable to two or more sites different from each other of the base BB. In this case, the port PT and the movable portion A are provided on respective attachment portions different from each other.

In addition, the site PX1 described above is an example of the first site and the site PX2 described above is an example of the second site. In addition, the opening HD1 described above is an example of the first opening and the opening HD2 is an example of the second opening.

As described above, the robot 1 includes the base (in the example described above, the base BB) and an attachment portion (in the example described above, the attachment portion L1 configured to have the members PL1 and PL2) which enables the object (in the example described above, each of the port PT and the movable portion A) to be attached to two or more sites (in the example described above, the site PX1 and the site PX2) different from each other of the sites of the base. In this manner, in the robot 1, it is possible to attach the object, which is desired by a user, to the site, which is desired by the user.

In addition, in the robot 1, the attachment portion is provided with at least one of the port (in the example described above, the port PT) that connects the wiring and the movable portion (in the example described above, the movable portion A). In this manner, in the robot 1, it is possible to attach, to a position that is desired by a user, at least one of the movable portion and the port to which the wiring is connected.

In addition, in the robot 1, a site to which the attachment portion is attachable includes the first site (in the example described above, the site PX1) provided with the first opening (in the example described above, the opening HD1) and the second site (in the example described above, the site PX2) provided with the second opening (in the example described above, the opening HD2), and the first opening and the second opening are connected to each other. In this manner, in the robot 1, it is possible to easily change the site to which the attachment portion is attached, by a user.

As described above, the embodiment of the invention is described in detail with reference to the figures; however, a specific configuration is not limited to the embodiment, and modification, replacement, removal, or the like may be performed without departing from the gist of the invention.

The entire disclosure of Japanese Patent Application No. 2016-240275, filed Dec. 12, 2016 is expressly incorporated by reference herein.

What is claimed is:

1. A robot comprising:
two members that relatively rotate around a rotary shaft,
wherein the position of the rotary shaft for at least one of the two members is changed.

2. The robot according to claim 1,
wherein the two members are an assembly of an arm and a base or an assembly of an arm and an arm.

3. The robot according to claim 1,
wherein each of the two members is an arm, and
wherein a predetermined position of one of the two members passes above or below the other member such that the two members rotate with respect to each other when viewed in an axial direction of the rotary shaft.

4. The robot according to claim 1, further comprising:
a connecting portion that connects the two members to each other,
wherein a connecting position between at least one of the two members and the connecting portion is changed.

5. The robot according to claim 1, further comprising:
a base,
wherein the two members are a first arm that is provided on the base and a second arm that is provided on the first arm, and
wherein the second arm is provided on the base on a side of an installation surface with respect to the first arm in the axial direction of the rotary shaft.

6. The robot according to claim 5, further comprising:
a robot control device that is provided in the base and controls the robot.

7. The robot according to claim 5,
wherein the second arm is provided with
a plurality of through-holes that penetrate through the second arm in the axial direction of the rotary shaft, and
an actuation shaft that penetrates through the first through-hole as one of the through-holes and a drive unit that drives the actuation shaft, and
wherein layout of wiring that is connected to the drive unit is performed through at least a portion of second through-holes which are one or more through-holes different from the first through-hole of the through-holes.

8. The robot according to claim 7,
wherein a portion or all of the one or more second through-holes are provided with a third through-hole that is connected to the second through-hole in a direction intersecting with an axial direction of the actuation shaft in the second arm.

9. The robot according to claim 8,
wherein wiring that is connected to an end effector provided on the actuation shaft passes through the third through-hole.

10. The robot according to claim 1, further comprising:
a base; and
an attachment portion that enables an object to be attached to two or more sites different from each other of sites of the base.

11. The robot according to claim 10,
wherein at least one of a movable portion and a port to which wiring is connected is provided as the object on the attachment portion.

12. The robot according to claim 10,
wherein a site to which the attachment portion is attachable includes a first site provided with a first opening and a second site provided with a second opening, and
wherein the first opening and the second opening are connected to each other.

13. A robot control device that controls the robot according to claim 1.

14. A robot control device that controls the robot according to claim 2.

15. A robot control device that controls the robot according to claim 3.

16. A robot control device that controls the robot according to claim 4.

17. A robot system comprising:
the robot according to claim 1; and
the robot control device that controls the robot.

18. A robot system comprising:
the robot according to claim 2; and
the robot control device that controls the robot.

19. A robot system comprising:
the robot according to claim 3; and
the robot control device that controls the robot.

20. A robot system comprising:
the robot according to claim 4; and
the robot control device that controls the robot.
